(19) United States
(12) Patent Application Publication
(10) Pub. No.: US 2024/0003784 A1
(43) Pub. Date: Jan. 4, 2024

(54) DIRECT MEASUREMENT OF COMPOSITION IN CHEMICAL PROCESSING EQUIPMENT TO OPTIMIZE PROCESS VARIABLES

(71) Applicant: Chemtech Services, Inc., Lockport, IL (US)

(72) Inventor: John F. Hart, Lockport, IL (US)

(21) Appl. No.: 17/856,713

(22) Filed: Jul. 1, 2022

(51) Int. Cl. G01N 1/22; G01N 30/72; G01N 30/88

(52) U.S. Cl. CPC G01N 1/22; G01N 30/7206; G01N 30/88; G01N 2001/2261; G01N 2030/8804; G01N 2030/025

(57) ABSTRACT

A method of extracting a vapor from chemical processing equipment which may be operated under pressure or vacuum conditions and adjusting the density, temperature, dilution, pressure and flow conditions for subsequently compositional analysis by chemical analysis equipment interfaced with computer controls which subsequently control the process variable related to operating chemical process equipment.

The present invention relates generally to methods and systems for the direct measurement of the chemical composition of vapors present in chemical processing equipment utilizing special sampling probes and intermediate chambers interfaced with analytical equipment such as gas chromatographs (GC), mass spectrometers (MS) or combinations thereof (GC-MS).

### BACKGROUND OF THE INVENTION

Certain conventional methods for determining the composition of chemicals being processed in chemical processing equipment require the collection of a liquid sample of the chemical stream under consideration, and the subsequent preparation of such sample which generally includes dilution in a known solvent, after which the diluted sample is introduced into analytical equipment such as a gas chromatograph or a mass spectrometer where the diluted sample is vaporized and processed through the analytical equipment detection system using a carrier gas. The conventional sampling process requires personnel to collect a liquid sample, carefully dilute the sample with a solvent, at precise weight ratios, to a specific concentration, and subsequently introduce the diluted sample into the analytical processing equipment. Subsequent to the introduction of the diluted sample into the analytical equipment, the processing of the sample in the analytical equipment requires a period of time which is typically longer than twenty minutes before the compositional information is available. The processing time between sampling and reviewing analytical results may exceed one hour during which time the operating variables in the chemical processing equipment may result in unacceptable compositions which may require additional processing. The current invention describes a more automated means of directly sampling vapor streams existing in the chemical processing equipment, which vapor streams may be introduced directly into analytical equipment thereby achieving expedited compositional information upon which the operating parameters of chemical processing equipment may be rapidly adjusted to achieve optimum processing results.

### BRIEF SUMMARY OF THE INVENTION

In certain preferred embodiments, the current invention does not require the use of personnel to perform chemical sampling procedures or mass sensitive solvent dilution of liquid chemical products which must be subsequently introduced into analytical equipment. The current invention utilizes special sampling apparatus consisting of a sampling probe, inserted into an existing vapor steam, and a downstream vapor chamber where vapors to be analyzed may be diluted prior to introduction into analytical equipment interfaced with the vapor chamber. The design of the sampling apparatus and downstream vapor chamber incorporates provisions for heating to maintain vapors in the vapor state and also for applying vacuum conditions which further preclude the transition of sample vapors into the liquid state. The vapor chamber also incorporates gas introduction ports in order to introduce a dilution gas or a purge gas for proper operation of the analytical equipment. Gasses such as nitrogen, argon, hydrogen or other gasses may be introduced into the vapor chamber for dilution or purge requirements.

More specifically, the present invention provides a method of direct sampling of vapor streams in chemical processing equipment where the chemical composition of such streams may be quickly determined allowing adjustments, if necessary, to the processing equipment to assure optimum processing results.

### BRIEF DESCRIPTION OF THE SEVERAL VIEWS OF THE DRAWINGS

Preferred embodiments of the present invention are described herein with reference to the drawings wherein:

FIG. 1 is a schematic diagram depicting the sampling apparatus of the present invention;

FIG. 2 is a schematic diagram depicting the vapor chamber of the present invention;

FIG. 3 is a schematic diagram depicting the integration of devices 1 and 10, which devices are illustrated in FIGS. 1 and 2;

FIG. 4 is a schematic diagram depicting one embodiment of FIG. 1 and FIG. 2;

FIG. 5 is a schematic diagram depicting a second embodiment of FIG. 1 and FIG. 2;

FIG. 6 is a schematic diagram depicting a third embodiment of FIG. 1 and FIG. 2;

FIG. 7 is a schematic diagram depicting a fourth embodiment of FIG. 1 and FIG. 2;

FIG. 8 is a schematic diagram depicting the design of a unique modification to a high vacuum, short path evaporator to accommodate the sampling apparatus embodied in FIG. 1.

### DETAILED DESCRIPTION OF THE INVENTION

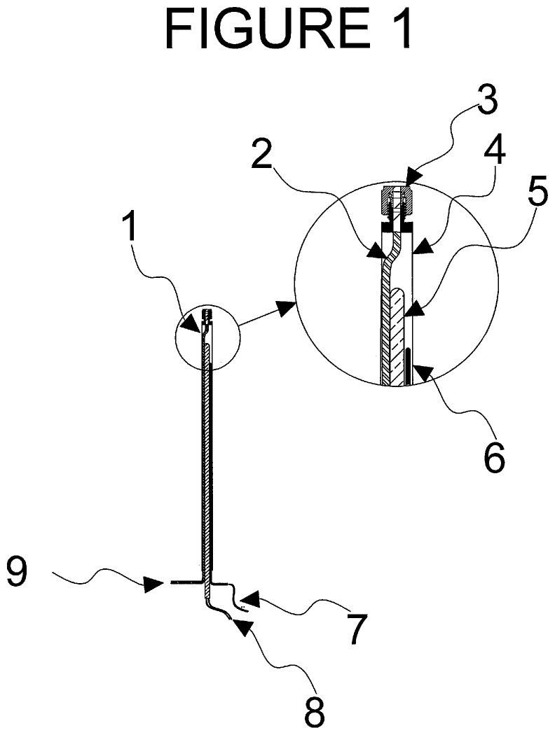

FIG. 1 shows an example of the basic principles of the present invention, exemplified as a simple prototype that was designed and fabricated in the facility of the Applicant to determine that the concept of using a vapor sampling apparatus could be incorporated in chemical processing equipment where boiling point vapors derived under pressure or vacuum conditions could be sampled directly from the processing equipment while in use. More specifically, FIG. 1 shows an example of a sampling apparatus 1 in which a chemical vapor sampling tube 2 is contained inside of a larger containment tube 4 which also contains an electrical heating device 5 and a thermocouple 6. The temperature inside of the containment tube is maintained at a stable, predetermined set-point using thermocouple 6 where its electrical signal wires 7 are interfaced with a PID, PLC, or DCS controller which will cycle power to the heating element 5 through electrical wires 8 in an on and off condition to maintain the temperature set-point conditions. The use of a heating element is desirable to preclude condensation of vapors inside of the sampling tube 2. The sampling tube is open to the atmosphere within the chemical processing vessel, while the heating element and thermocouple are isolated from the atmosphere within the chemical processing vessel using a compression seal 3 at the end of the containment tube 4. Heating element 5 normally derives power from a 120 or 240 VAC power connection. Sampling tube 2 is ultimately interfaced with a chemical analysis device, such as GC, MS or GC-MS where chemical analysis is performed. It is desirable that all the elements in sampling apparatus 1 are fabricated using corrosion resistant metals such as 316 Stainless steel to preclude reaction with chemical vapors.

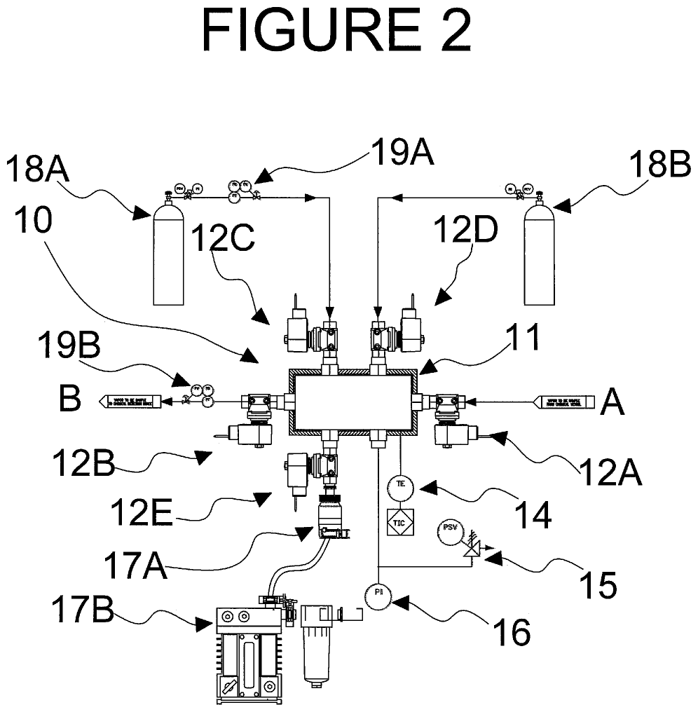

In many instances it is preferred to control the flow rate, molecular density and temperature of the chemical vapors derived from sample tube 2, prior to introduction into a chemical analysis device. FIG. 2 depicts a vapor chamber 10 which is interfaced with sampling tube 2 of device 1 for the purpose of collecting vapors and diluting them for subsequent injection to a chemical analysis device such as a GC, MS or GC-MS. Vapor chamber 10 is an assembly of multiple components with the primary component being the basic chamber 11, or enclosure 11, wherein other components would typically be attached, preferably welded, to the basic chamber 11. Chamber 11 may vary with respect to the internal volume from 25 cubic centimeters to 5,000 cubic centimeters or larger with smaller volumes of 50 to 200 cubic centimeters preferred. The most desirable geometry for chamber 11 is considered to be a round tube, but alternative geometries such as a square tube can also be utilized. Vapor chamber 10 includes a number of ports, attached to chamber 11, where vapor flow is controlled by electrically operated solenoid valves 12A through 12E that are electrically interfaced with a computer process control system such as a programmable logic control (PLC) and distributed control systems (DCS). Solenoid valves 12A through 12E are in a normally closed position and the computer process control system will open the solenoid valves as required for programming sequencing of vapor through vapor chamber 10. Anticipated process flows through solenoid valves 12A through 12E include: 12A where the molecular flow A to be analyzed enters the vapor chamber when 12A is in the open position; 12B where the molecular flow B containing molecules to be analyzed exits the vapor chamber when 12B is in the open position; 12C which is connected to device 18A which represents a regulated carrier gas used to dilute and transfer molecules in the vapor chamber 10, when 12C is in the open position, to the chemical analysis device prior to the activation of solenoid valve 12B. 18A's regulated gas flow is controlled using a mass flow controller 19A, to facilitate proper molecular density for subsequent analysis; 12D which is connected to device 18B representing a regulated inert gas used to purge molecules in the vapor chamber 10, and potentially purge the chemical analysis device, prior to introduction of another molecule for analysis; 12E which is connected to a duel stage rotary vacuum pump 17B with a turbomolecular booster 17A, which when activated with 12E in the open position, can be used to evacuate vapor chamber 10 during a gas purge cycle and can also be used to assure molecular flow of chemical vapors collected using sampling apparatus 1, into the vapor chamber. Vacuum system 17 is illustrated as a two-stage rotary vane pump 17B augmented with a vacuum booster 17A, such as a turbo molecular vacuum pump, when lower absolute pressures (i.e., higher vacuum levels) below 0.010 mm Hg., are required.

There are additional devices which could be used in conjunction with the vapor chamber, and such devices will be interfaced with an additional port in the vapor chamber which port will always remain open and not require an additional solenoid valve. Such devices include a pressure indicator 16 which is interfaces with the computer control system, and a pressure relief device 15 which precludes an excess pressure build during the operation of the vapor chamber 10. In addition, a temperature element or thermocouple 14 is connected with the computer control system for the purpose of maintaining a constant temperature in the vapor chamber to avoid condensation or precipitation of the molecules to be tested. There is no specific limit to the number of ports which can be attached to chamber 11 and other ports may be added which could serve other purposes.

Similar to sampling apparatus 1, it is desirable that all the elements in vapor chamber 10 are fabricated using corrosion resistant metals such as 316 Stainless steel to preclude reaction with chemical vapors.

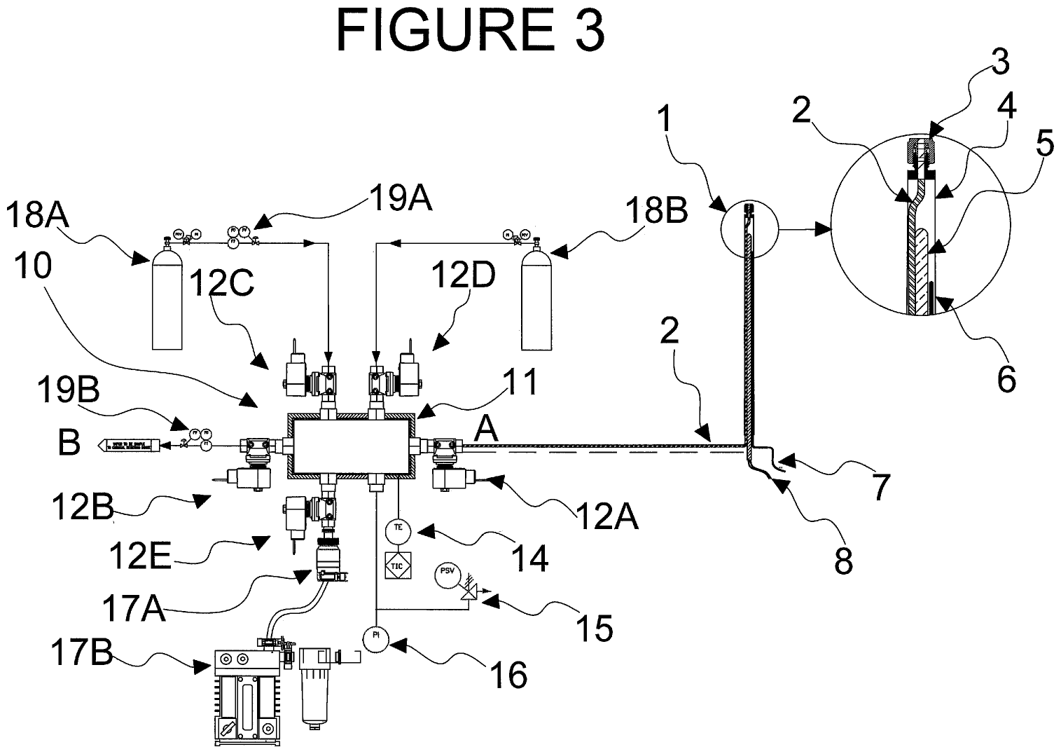

The devices 1 and 10 described above and depicted in FIGS. 1 and 2, are typically integrated in close proximity to minimize the travel distance from the vapor collection point 3 of device 1, to the inlet point A of device 10. FIG. 3 illustrates the integration of device 1 with device 10. FIG. 3 depicts the extension of sampling tube 2 of device 1, to provide the vapor supply into vapor chamber 10 through solenoid valve 12A at point A. The dotted line below sampling tube 2 denotes the use of heat tracing, supplied by either an electrical resistance heater or through the use of a liquid heat transfer fluid in a jacketed or adjacent tube configuration. The addition of heat tracing precludes any vapors condensing into a liquid state prior to entry into vapor chamber 10.

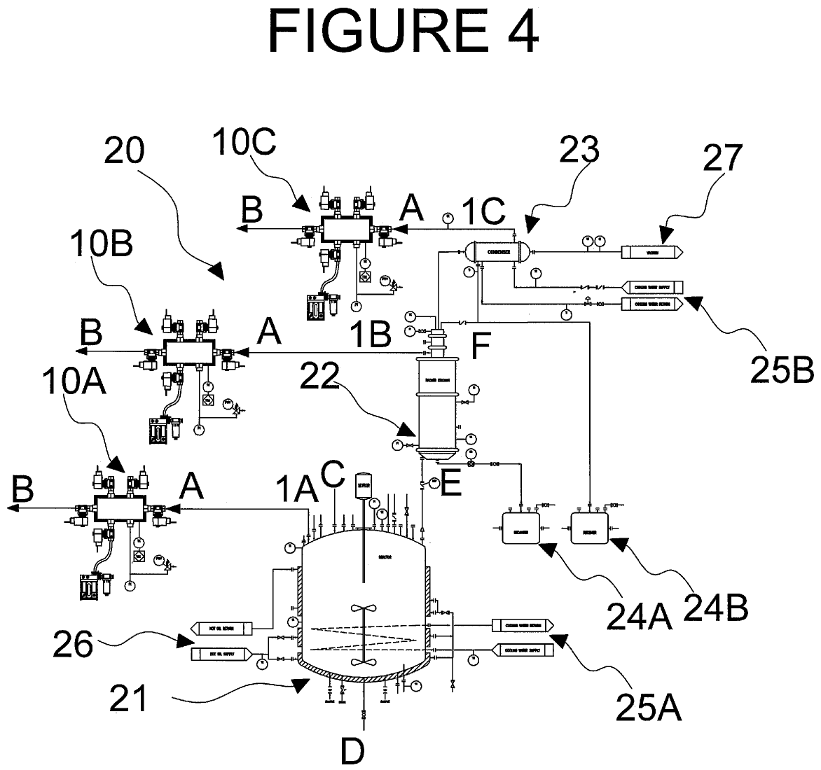

The devices 1 and 10 described above and depicted in FIGS. 1 and 2, can be applied to a wide spectrum of chemical processing equipment. FIGS. 4 through 8 illustrate the application of devices 1 and 10 in different types of chemical processing equipment, and all of which are likely to contain molecules in the vapor state where compositional information may allow optimization of the chemical process. FIG. 4 depicts a typical chemical reactor system 20 where through the control of temperature and pressure over a reaction cycle period chemical raw materials can be reacted or processed to derive a different chemical product. The chemical reactor system may include the reactor 21, a distillation column 22, and a condenser 23. The reactor may also include a variety of ports (or nozzles) in both the upper dish and lower dish, not described in in detail for FIG. 3, normally used for functions such raw material charges, material discharge (D) and instrumentation. The reactor system also encompasses temperature and pressure control such as provided by a heating loop 26, or cooling loops 25A and 25B. Pressure control is exercised through the vapor discharge port of condenser 23 which is interfaced with a vacuum system 27 which may employ more than one vacuum pump.

A reactor system 20 as described in FIG. 4 would typically include discharge nozzles from the included components 21, 22, and 23 where chemical vapor may be collected and analyzed which would provide valuable information related to process control of the system to assure a quality product is manufactures. FIG. 4 depicts the inclusion of vapor chambers 10A, 10B and 10C in the reactor system where vapors may be collected using vapor sampling devices 1A, 1B and 1C respectively, installed to collect vapors in the reactor head space, the distillation column head space or the condenser head space, which vapors could be diluted if necessary for subsequent transfer to a chemical analysis device such as a GC, MS or GC-MS for compositional analysis.

In the chemical distillation field, reactors represent one class of processing equipment which can perform chemical distillations but there is another class of chemical processing equipment dedicated to distillation referred to as “thin film distillation systems” which process a continuous stream of product without interruption.

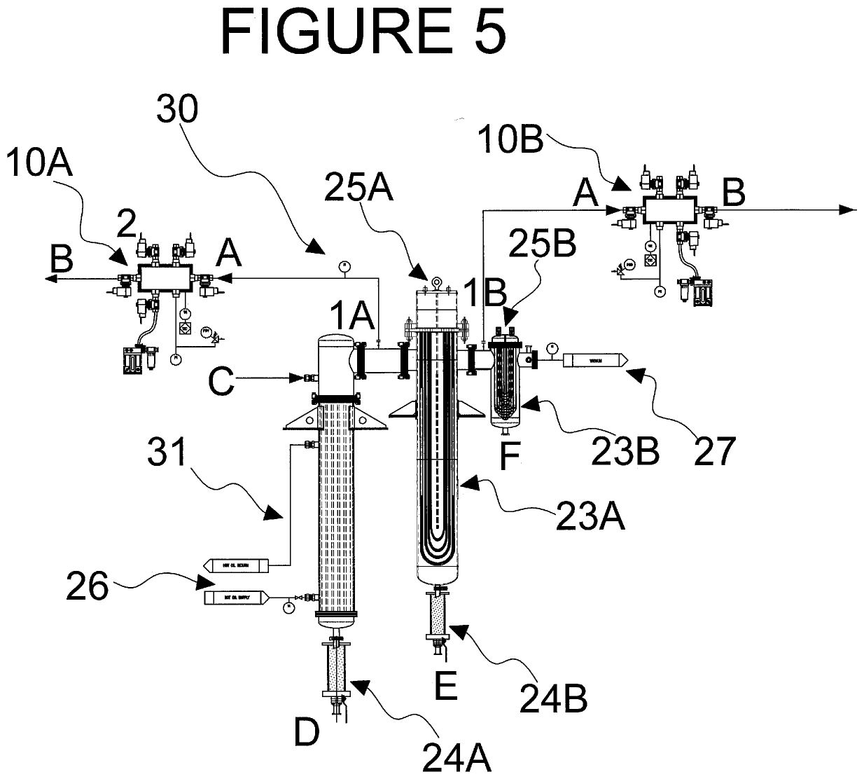

FIG. 5 illustrates one type of thin film distillation system, a falling film distillation system 30, where devices 1 and 10 may be installed for the purpose of collecting chemical vapors for subsequent compositional analysis which may influence process control of the system 30. The falling film system typically includes vessels such as: the falling film evaporator 31, an external condenser 23A, and a secondary condenser 23B (also referred to as a cold trap). The falling film system normally includes additional components such as intermediate receiver/sight glass components 24A and 24B which receive products from components 31 and 23A. The falling film distillation system 30 includes provisions for temperature and pressure control similar to chemical reactor system such as heating loop 26, cooling loops 25A and 25B, and a vacuum system 27. Other elements of the falling film system 30 are similar to the reactor system such as raw material inlet port C and product discharge ports D, E and F. It is also expected that the key operating parameters of the falling film system 30, such as feed rate at product inlet C, evaporator 31 temperature control 26, primary condenser 23A temperature control 25A, secondary condenser 23B temperature control 25B will be monitored and adjusted by a computer process control system, such as a PLC or DCS control system. The falling film system is different from the reactor system because it operates with a continuous chemical product flow basis compared to the fixed weight batch processing used in a reactor system, therefore continuous process control is very important to assure the quality of the finished chemical products. FIG. 5 depicts two locations where continuous chemical analysis of vapor molecules will facilitate maintaining the quality of the refined distillate products within chemical specifications. Vapor sampling apparatus 1A is located downstream of the falling film 31 vapor head, and vapor sampling apparatus 1B is located downstream of the vapor discharge port of condenser 23A. Vapor sampling apparatus 1A and 1B processed through vapor chambers 10A and 10B, respectively will provide a refined input vapor for subsequent compositional analysis. Chemical composition analysis will be obtained from a chemical analysis device, such as GC, MS or GC-MS, interfaced downstream of vapor chambers 10A and 10B. It is anticipated that based upon the compositional analysis performed by the chemical analytical device that date will be transferred and interpreted by a computer process control system such as a PLC or DCS and the process operating variables of the falling film system, such as feed rate, process temperatures and process pressures will be adjusted to conform with preprogrammed parameters to assure optimum processing of chemicals.

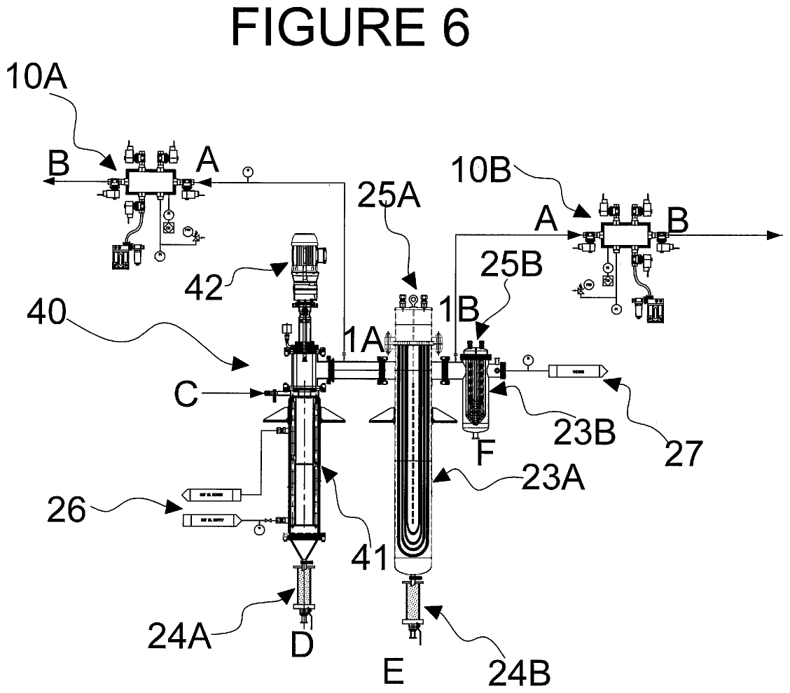

FIG. 6 illustrates a second type of thin film distillation system, a wiped film distillation system 40, where devices 1 and 10 may be installed for the purpose of collecting chemical vapors for subsequent compositional analysis which may influence process control of the system 40. The wiped film system typically includes vessels such as: the wiped film evaporator 41, equipped with a motor 42 for rotating a wiper system dedicated to maintaining a thin film on the wall of evaporator 41, an external condenser 23A, and a secondary condenser 23B (also referred to as a cold trap). The wiped film system normally includes additional components such as intermediate receiver/sight glass components 24A and 24B which receive products from components 41 and 23A. The wiped film distillation system 40 includes provisions for temperature and pressure control similar to the falling film system 30, such as heating loop 26, cooling loops 25A and 25B, and a vacuum system 27. Other elements of the wiped film system 40 are similar to falling film system 30 such as raw material inlet port C and product discharge ports D, E and F. It is also expected that the key operating parameters of the wiped film system 40, such as feed rate at product inlet C of evaporator 41, the wiper speed in evaporator 41 controlled with motor 42, temperature control 26, primary condenser 23A temperature control 25A, secondary condenser 23B temperature control 25B will be monitored and adjusted by a computer process control system, such as a PLC or DCS control system. The wiped film system similar to the falling film system 30 operates with a continuous chemical product flow basis and like falling film system 30, continuous process control is very important to assure the quality of the finished chemical products. FIG. 6 depicts two locations where continuous chemical analysis of vapor molecules will facilitate maintaining the quality of the refined distillate products within chemical specifications. Vapor sampling apparatus 1A is located downstream of the wiped film 31 vapor head, and vapor sampling apparatus 1B is located downstream of the vapor discharge port of condenser 23A. Vapor sampling apparatus 1A and 1B processed through vapor chambers 10A and 10B, respectively will provide a refined input vapor for subsequent compositional analysis. Chemical composition analysis will be obtained from a chemical analysis device, such as GC, MS or GC-MS, interfaced downstream of vapor chambers 10A and 10B. It is anticipated that based upon the compositional analysis performed by the chemical analytical device that date will be transferred and interpreted by a computer process control system such as a PLC or DCS and the process operating variables of the falling film system, such as feed rate, process temperatures and process pressures will be adjusted to conform with preprogrammed parameters to assure optimum processing of chemicals.

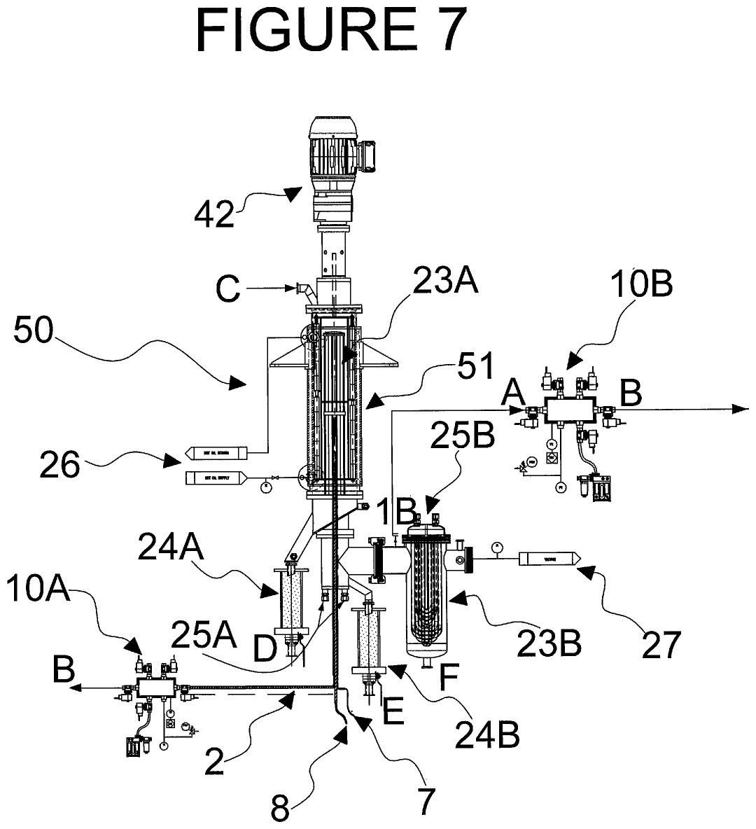

FIG. 7 illustrates a third type of thin film distillation system, which is a subset of the wiped film distillation system 40, and is referred to as a short path distillation system 50. The short path distillation system differs from the wiped film distillation system 40 in that the primary condenser 23A is contained within evaporator 51. The benefit of the positioning the primary condenser 23A within evaporator 51 is that the internal condenser provides an immediate pressure drop inside of the evaporator 51 which causes the evaporator to operate at extremely low pressures (or high vacuum) of approximately 0.001 mm Hg. Similar to other types of thin film distillation systems, devices 1 and 10 may be installed for the purpose of collecting chemical vapors for subsequent compositional analysis which may influence process control of the system 50. The short path system 50 typically includes vessels such as: the short path evaporator 51, equipped with a motor 42 for rotating a wiper system dedicated to maintaining a thin film on the wall of evaporator 51, an internal condenser 23A, and a secondary condenser 23B (also referred to as a cold trap). The short path system normally includes additional components such as intermediate receiver/sight glass components 24A and 24B which receive products from components 51 and 23A. The short path distillation system 50 includes provisions for temperature and pressure control similar to the wiped film system 40, such as heating loop 26, cooling loops 25A and 25B, and a vacuum system 27. Other elements of the short path system 50 are similar to wiped film system 40 such as raw material inlet port C and product discharge ports D, E and F. It is also expected that the key operating parameters of the short path system 50, such as feed rate at product inlet C of evaporator 51, the wiper speed in evaporator 51 controlled with motor 42, short path evaporator 51 temperature control 26, primary condenser 23A temperature control 25A, secondary condenser 23B temperature control 25B will be monitored and adjusted by a computer process control system, such as a PLC or DCS control system. The short path system similar to the wiped film system 40 operates with a continuous chemical product flow basis and like wiped film system 40, continuous process control is very important to assure the quality of the finished chemical products. FIG. 7 depicts two locations where continuous chemical analysis of vapor molecules will facilitate maintaining the quality of the refined distillate products within chemical specifications. Vapor sampling apparatus 1A is located inside of the short path evaporator 51, with the vapor sampling apparatus installed adjacent to the primary condenser 23A and inside of evaporator 51. Vapor sampling apparatus 1B is located downstream of the vapor discharge port of short path evaporator 51. Vapor sampling apparatus 1A and 1B processed through vapor chambers 10A and 10B, respectively will provide a refined input vapor for subsequent compositional analysis. Chemical composition analysis will be obtained from a chemical analysis device, such as GC, MS or GC-MS, interfaced downstream of vapor chambers 10A and 10B. It is anticipated that based upon the compositional analysis performed by the chemical analytical device that date will be transferred and interpreted by a computer process control system such as a PLC or DCS and the process operating variables of the short path distillation system, such as feed rate, process temperatures and process pressures will be adjusted to conform with preprogrammed parameters to assure optimum processing of chemicals.

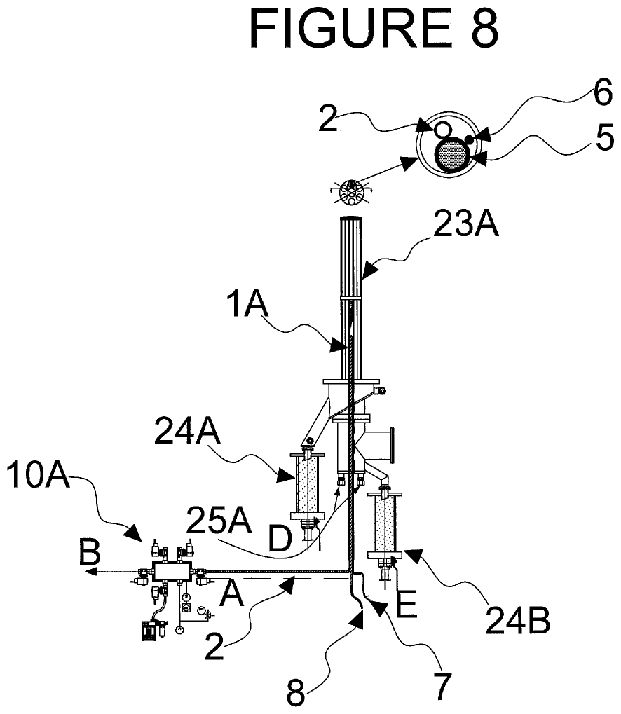

FIG. 8 is a more detailed illustration of the lower section of short path evaporator 51, which contains the internal condenser 23A tube bundle. In this figure, the positioning of the chemical vapor sampling apparatus 1A is in the proximity of the condenser tube elements and extends approximately to the middle of the evaporator condenser tube bundle, with the vapor inlet 3 positioned to allow a near homogeneous collection of vapors to be collected by sampling apparatus 1A. The positioning of the vapor sampling apparatus is critical to assure a meaningful evaluation of the vapor composition which is ultimately condensed to a liquid state and discharged from the evaporator through port E. A cross section of the vapor sampling apparatus is also illustrated in FIG. 7 with the vapor sampling tube 2, the electrical heating device 5 and the temperature sensing device 6 clearly illustrated. The vapor discharge from the sampling tube 2 will be subsequently interfaced with the vapor chamber 10A, port A for concentration and pressure adjustment prior to discharge to the chemical analysis device.

While various embodiments of the present invention have been shown and described, it should be understood that other modifications, substitutions and alternatives may be apparent to one of ordinary skill in the art. For example, components from the different embodiments can be substituted for similar components in other embodiments, thereby creating new embodiments. Such modifications, substitutions and alternatives can be made without departing from the spirit and scope of the invention, which should be determined from the appended claims.

Various features of the invention are set forth in the appended claims.

What is claimed is:

1. A method of collecting chemical vapors from chemical processing equipment method comprising:
providing at least one sampling apparatus in communication with the chemical processing equipment; and
collecting vapors from an interior of the chemical processing equipment in the sampling apparatus, wherein the vapors include at least one chemical,
wherein the sampling apparatus comprises:
an outer containment tube;
a sampling tube positioned within the outer containment tube, wherein the sampling tube is configured and arranged for collecting the vapors;
a compression seal positioned within one end of the outer containment tube and that is configured and arranged for providing an air tight seal between the outer containment tube and the sampling tube and for precluding outside vapors from entering the outer containment tube;
a heating element configured and arranged to provide heat to the vapors within the sampling tube to maintain molecules of the vapors in the sampling tube in a vapor state; and
a temperature measuring device configured and arranged to measure an interior temperature of the outer containment tube and to transmit an electrical signal to an outside computer control system that is configured and arranged to adjust an operating temperature of the heating element.

2. The method according to claim 1, wherein the outer containment tube comprises a stainless steel, or other chemical resistant alloy, tube.

3. The method according to claim 1, further comprising a vapor chamber that is in communication with the sampling apparatus and that is situated downstream of the sampling apparatus and upstream of a chemical analysis device.

4. The method according to claim 1, wherein the sampling apparatus is in direct communication with a chemical analysis device.

5. The method according to claim 3, wherein:
the vapor discharged into the sampling tube is processed into the vapor chamber in order to modify the density and temperature of the vapor; and
the vapor chamber contains multiple ports to facilitate the modification and transmission of the vapor to the chemical analysis device.

6. The method according to claim 5, wherein said ports comprise:
an entry port configured for entry of the vapor into the vapor chamber; and
an exit port that is separate from the entry port and that is configured for exit of the vapor from the vapor chamber.

7. The method according to claim 5, wherein said ports comprise an introduction port for introducing a gas into the vapor chamber, wherein the gas is used to dilute the density of the vapor and to serve as a carrier gas to convey the vapor to the chemical analysis device located downstream of the vapor chamber.

8. The method according to claim 5, wherein said ports comprise a purge port for introducing a purge gas to the vapor chamber, wherein the purge gas is used to clean the vapor chamber prior to the introduction of successive vapor charges.

9. The method according to claim 5, wherein said ports comprise a vacuum port for the interfacing of the vapor chamber with a vacuum system used, wherein the vacuum port maintains the flow of vapor collected from the chemical processing equipment into the vapor chamber.

10. The method according to claim 5, wherein said ports comprise a measurement port for measuring absolute pressure within the vapor chamber, and wherein eh measurement port is also configured for vapor discharge if pressures within the vapor chamber exceed a predetermined process control pressure.

11. The method according to claim 5, further comprising:
heating the vapor chamber to assure the maintenance of molecules of the vapor within the vapor chamber in the vapor state, where the heating is applied via an electrical heating mantle

12. The method according to claim 5, further comprising:
heating the vapor chamber to assure the maintenance of molecules of the vapor within the vapor chamber in the vapor state, where the heating is applied via a heating jacket where heat transfer fluids are used to control temperatures.

13. The method according to claim 11, further comprising:
using a temperature measuring device that is interfaced to a computer control system which subsequently monitors the temperature of the vapor chamber and adjusts the temperature within the vapor chamber to maintain predetermined operating parameters.

14. The method according to claim 12, further comprising:
using a temperature measuring device that is interfaced to a computer control system which subsequently monitors the temperature of the vapor chamber and adjusts the temperature within the vapor chamber to maintain predetermined operating parameters.

15. The method according to claim 1, wherein:
the chemical processing equipment comprises a batch type chemical reactor for sampling vapors for the purpose of determining their chemical composition.

16. The method according to claim 1, wherein:
the chemical processing equipment comprises a continuous flow chemical reactor for sampling vapors for the purpose of determining their chemical composition.

17. The method according to claim 1, wherein:
the chemical processing equipment comprises a thin film distillation system for sampling vapors for the purpose of determining their chemical composition.

18. The method according to claim 3, wherein the chemical analysis device comprises a gas chromatograph.

19. The method according to claim 3, wherein the chemical analysis device comprises a mass spectrometer.

20. The method according to claim 3, wherein the chemical analysis device comprises a mass spectrometer detector.
